(19) United States
(12) Patent Application Publication
(10) Pub. No.: US 2007/0035956 A1
(43) Pub. Date: Feb. 15, 2007

(54) Lighted rod assembly and method of use

(76) Inventor: Clyde N. Topps, Reno, NV (US)

Correspondence Address: KLARQUIST SPARKMAN, LLP, 121 SW SALMON STREET, SUITE 1600, PORTLAND, OR, 97204, US

(21) Appl. No.: 11/504,278

(22) Filed: Aug. 14, 2006

Related U.S. Application Data
(60) Provisional application No. 60/707,786, filed on Aug. 12, 2005.

(51) Int. Cl. F21V 33/00; B62J 6/00

(52) U.S. Cl. 362/473

(57) ABSTRACT

A lighted rod assembly, such as for mounting on a vehicle, such as a bicycle, motorcycle, wheelchair, scooter, baby stroller, and the like. In certain embodiments, the lighted rod assembly includes a power supply line extending along a rod and a plurality of electric light sources spaced along the length of the rod and in power supply communication with the power supply line. A power source is attachable to the power supply line to energize the light sources, thereby illuminating the rod. A flag may be mounted on the rod to increase the visibility of the assembly.

### CROSS REFERENCE TO RELATED APPLICATION

The present application claims the benefit of U.S. Provisional Application No. 60/707,786, filed Aug. 12, 2005, which is incorporated herein by reference.

### FIELD

The present disclosure is directed a lighted rod assembly and methods of use. In certain embodiments, the lighted rod assembly can be used to increase a user's visibility or for ornamentation.

### BACKGROUND

There is a great number of bicycles and motorcycles being utilized on the highways and roads today. As such, the provision of adequate safety devices for detecting bicycles, motorcycles and similar vehicles by oncoming traffic is of great importance in reducing the risk of accidents.

One known safety device is a conventional flag pole or rod that can be mounted to a vehicle. While a conventional flag rod can function as a safety device for day time use in well illuminated locations, its efficacy at night or other low light conditions is limited and less than optimal

U.S. Pat. No. 4,274,127, however, discloses a flag pole device that incorporates a lamp to illuminate a portion of the device. More specifically, the device disclosed in the '127 patent includes an elongated pole mounted to a bicycle, a lamp housing mounted to the upper end of the pole, and a rod having optical properties extending upwardly from the lamp housing. The '127 device's one light source, at the upper end of the rod, may result in illuminating only a relatively small section of the length of the rod assembly, and the single light source and associated illuminated structure can be relatively difficult to locate as being at particular distance from, or moving in a particular direction with respect, to a remote observer. This problem becomes exacerbated in very low or no light conditions.

Another drawback of the '127 device is that the length of the device i understood to be fixed and cannot be adjusted to suit a particular or differing applications.

### SUMMARY

In one aspect, the present disclosure provides a lighted rod assembly. Embodiments of the lighted rod assembly can have particular applicability as a safety device for increasing the visibility of vehicles, such as bicycles, motorcycles, wheelchairs, scooters, baby strollers, and the like. The lighted rod assembly also can be mounted to various other devices or structures to increase visibility and/or for decorative purposes.

In certain embodiments, the lighted rod assembly includes a power supply line extending along a rod and a plurality of electric light sources spaced along the length of the rod and in power supply communication with the power supply line. A flag may be mounted on the rod. A power source is attachable to the power supply line to energize the light sources.

In certain embodiments, the lighted rod assembly is economical and relatively easy to make, use and maintain. Additionally, in certain embodiments, the rod assembly is formed from multiple, interconnected rod sections, which allows the length of the assembly to be adjusted to suit a particular application by adding or removing rod sections.

In some implementations, although not necessarily, the power supply line extends along a substantial length of the rod, providing power to a plurality of small light sources, such as light bulbs or LED's, mounted along the rod. The power supply line as well as the light sources can be housed within the internal passageway of the rod. The power supply line or power source may also include circuitry, such as circuitry to switch the lights of the lighted rod assembly “on” or “off,” cause one or more of the light sources to flash, or cause one or more of the light sources to vary in light emitting intensity.

In some embodiments, the lighted rod assembly is mountable to, and extends from, transportation apparatus, such as motorcycles, bicycles, scooters, wheelchairs, or baby strollers. In certain implementations, the lighted rod assembly can increase a user's visibility and the visibility of the vehicle on which it is mounted, for example, to oncoming traffic, including when used in full daylight or at night or other low light conditions. In some implementations, multiple light sources along the rod can make the lighted rod specifically and associated apparatus or persons easier to locate and to identify as moving in a direction with respect to a remote observance, such as a human having stereo vision.

The rod may have various shapes and sizes. For example, in one embodiment, the rod may be cylindrical for projecting upwardly from an associated user or transportation apparatus. Alternatively, the rod may have a square cross-section and project longitudinally upwards. Alternatively, in another embodiment, the rod may be bent, such as in a circle or an arch. The rod may be of various lengths.

In certain embodiments, the rod may be comprised of various materials and the power supply harness may be mounted along the length of the rod in various manners. For example, the lighted rod assembly may be made of a hollow fiberglass material through with a power supply harness may pass. Alternatively, the rod may be made of a solid material and a power supply/light harness may be mounted to the rod on the external periphery of the rod with various types of ties or fasteners. Alternatively, the rod may be made of a generally solid electrically insulating material, such as a plastic or fiberglass, surrounding multiple axially extending conductive elements, such as metal wires or rods, which may be molded within the interior of the electrically isolating material.

In particular embodiments, at least a majority of the length of the rod assembly is made of transparent or translucent materials so that the majority of the length of the rod assembly can be illuminated by the light sources. In some implementations, substantially the entire length, or the entire length, of the rod assembly is transparent or translucent so that substantially the entire length, or the entire length, can be illuminated.

In certain embodiments, the rod assembly can include a bright colored flag or banner attached to the end of the rod opposite its base supported by the user or transportation apparatus. The flag or banner may have indicia printed thereon, and both the flag or banner and rod may comprise additional light reflective or luminescent material to further enhance visibility.

Additional light emitting elements can be mounted to the flag or banner. These or other of the light sources or other materials on the assembly may be arranged to convey indicia, such as the name of a sports team, military service affiliation, product advertisement, trademark, or notification of need for assistance by the user.

In use, certain embodiments of the lighted rod assembly can be easily mounted to any of various transportation apparatus, such as motorcycles, bicycles, scooters, wheelchairs, or baby strollers, for use as a safety device. In one implementation, for example, the lighted rod assembly can be easily mounted on a bicycle hub by loosening the skewer of one of the bicycle hubs (for example the rear hub), placing a mounting bracket on the skewer, and tightening the skewer to secure the lighted rod assembly in place. In another implementation, the lighted rod assembly can be mounted to a motorcycle or other vehicle having an existing electrical system. The wiring of the lighted rod assembly can then be connected to the existing electrical system to power the light sources of the rod assembly.

In one embodiment, a lighted rod assembly for mounting to a vehicle comprises an elongated rod, a plurality of electric light sources spaced along the length of the rod, a power source electrically connected to the light sources, and a mounting bracket supporting the rod and configured to be mounted on the vehicle.

In another embodiment, an assembly comprises a vehicle, and a lighted rod assembly mounted to the vehicle. The lighted rod assembly can comprise an elongated rod and a plurality of light sources mounted at spaced apart locations along the length of the rod.

In yet another embodiment, a lighted rod assembly for mounting to a vehicle comprises an elongated rod. The rod comprises a plurality of rod sections and sleeve sections, each sleeve section being positioned between two rod sections and having open ends that receive respective end portions of the rod sections. The lighted rod assembly further includes a plurality of electric light sources positioned in the sleeve sections, a power source electrically connected to the light sources, and a mounting bracket supporting the rod and configured to be mounted on the vehicle.

In still another embodiment, a lighted rod assembly for mounting to a vehicle comprises an elongated rod. The rod comprises a plurality of rod sections and sleeve sections, each sleeve section being positioned between two rod sections and having open ends that receive respective end portions of the rod sections, with one of said rod sections comprising a lower rod section. The lighted rod assembly can further include a flag mounted to the rod assembly, a plurality of LEDs positioned in the sleeve sections at spaced apart locations along the length of the rod assembly, and a mounting bracket configured to be mounted on the vehicle, with the lower rod section being secured to the mounting bracket. A power source can be mounted adjacent the mounting bracket and can comprises one or more batteries. A wiring harness extends through the rod assembly and is electrically connected to the LEDs and the power source, wherein the LEDs illuminate substantially the entire length of the rod assembly when energized by the power source.

It can thus be seen that there are many aspects of the present disclosure, including many other additional or alternative features that will become apparent as this specification proceeds. It is therefore understood that the scope of the invention is to be determined by the claims as issued and not by whether the claim subject matter solves any particular problem or all of them, provides any particular features or all of them, or meets any particular objective or group of objectives set forth in the Summary above.

### BRIEF DESCRIPTION OF THE DRAWINGS

FIG. 1 is a side elevation view of a lighted rod assembly, according to one embodiment.

FIG. 2 is an exemplary electrical schematic of the lighted rod assembly of FIG. 1.

FIG. 3 is an enlarged, exploded perspective view illustrating the assembly of two rod sections and a sleeve section of the rod assembly.

FIG. 4 is a side elevation view of a bicycle and a lighted rod assembly mounted to the rear skewer of the bicycle, according to another embodiment.

FIG. 5 is an enlarged, partial view of the lighted rod assembly of FIG. 4, showing the mounting bracket and power supply mounted adjacent the rear hub of the bicycle.

FIG. 6 is an enlarged view of the mounting bracket and power supply of a lighted rod assembly, according to another embodiment, shown mounted to the rear skewer of a bicycle.

FIG. 7 is a side elevation view of a wheelchair and a lighted rod assembly mounted to the wheelchair, according to another embodiment.

FIG. 8 is an enlarged, partial view of the lighted rod assembly of FIG. 7, showing the mounting bracket of the lighted rod assembly.

FIG. 9 is a side elevation view of a wheelchair and a lighted rod assembly mounted to the wheelchair, according to another embodiment.

FIG. 10 is a rear view of a motorcycle and a lighted rod assembly mounted to the motorcycle, according to another embodiment.

FIG. 11 shows an electrical connector connecting the electrical wiring of the lighted rod assembly of FIG. 11 to the electrical wiring of the motorcycle.

### DETAILED DESCRIPTION

As used herein, the singular forms “a,” “an,” and “the” refer to one or more than one, unless the context clearly dictates otherwise.

As used herein, the term “includes” means “comprises.” For example, a device that includes or comprises A and B contains A and B but may optionally contain C or other components other than A and B. A device that includes or comprises A or B may contains A or B or A and B, and optionally one or more other components such as C.

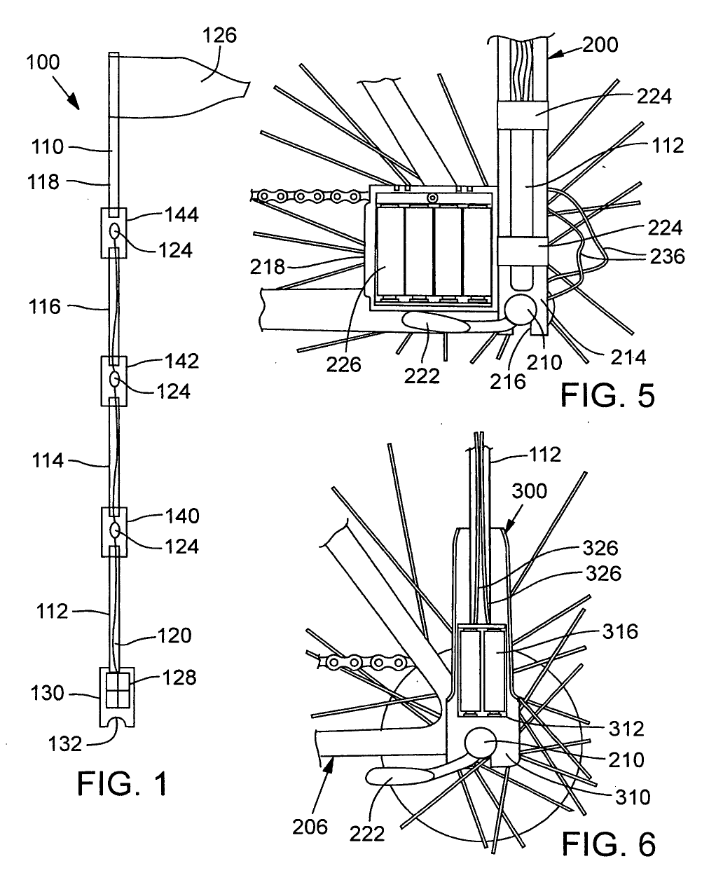

FIG. 1 is a general schematic diagram of certain embodiments of a lighted rod assembly apparatus 100. The assembly 100 can be mounted to a vehicle, such as a bicycle, motorcycle, wheelchair, and the like, and therefore can function as a safety device for increasing the visibility of the vehicle to oncoming traffic. The assembly 100 is particularly useful for night time traveling due to the light produced by the assembly, but can also serve as an effective safety device for day time traveling, especially when a flag is mounted to the assembly.

The lighted rod assembly 100 in the illustrated embodiment includes an elongated generally cylindrical rod 110 with a power supply harness 120. Other shapes may be used for the rod 110, such as rods with hexagonal or square cross-sections. Depending on the design of the lighted rod assembly 100, the rod 110 may be hollow or solid. In addition, the rod 110 may arcuate and include various curves, coils, or loops. The rod 110 may be made from any suitable material. Suitable materials include generally rigid plastic materials or fiberglass. In applications where lights are to be placed inside the rod 110, suitable materials are generally transparent or translucent and may be tinted. The rod 110 may be any desired length, such as 1, 2, 3, 4, 5, or 6 feet in length. The rod may be any desired diameter, such as ⅛, ¼, ½, or 1 inch in diameter.

The power supply harness 120 may include one or more pairs of electrically conductive wires, mounted within an internal, axially extending passage in the rod assembly 100. The wires may be coated, such as with plastic, or may be bare. In at least certain embodiments, the wires are bare wires embedded in the material forming the rod 110.

A plurality of light emitting sources 124, such as flashlight lamps, small light bulbs (e.g., conventional incandescent lamps), fuse lights (such as 1 inch long fuse lights), LEDs, or other light sources or luminescent materials, are mounted within or on the rod 110, and are electrically connected to the power supply harness 120, at various intervals, which may be the same or may vary, along the length of the rod 110. The light sources 124 may be soldered to the power supply harness 120 or fastened to the harness 120 with other electrical connectors, including appropriate wires from the power supply harness 120 to appropriate contacts on the light emitting sources 124. In the illustrated embodiment, the light emitting sources 124 and the wiring harness 120 are positioned within the axially extending passage of the rod 110. Alternatively, the light emitting sources 124, and associated wiring harness 120, may be secured to the external periphery of the rod 110 by plastic ties (not shown).

Although less desirable, in other embodiments the rod assembly 100 is provided with only a single light source 124.

In particular embodiments, the light sources 124 are LEDs, which consume less energy and are smaller in size and weight than conventional incandescent light bulbs. Advantageously, by utilizing LEDs, several light sources can be placed along the length of the rod 110 without significantly increasing the power requirements or the overall size or weight of the device, compared to prior devices that utilize incandescent lamps.

As best shown in FIG. 1, the entire length of the rod 110 desirably is made of a transparent or translucent material, and therefore the light sources 124 can illuminate the entire rod for increased visibility of the device. Thus, when used as a safety device on a vehicle, even in low light situations, an observer (such as the driver of an oncoming vehicle) can see the entire length of the rod and can more accurately assess the relative size of the vehicle to be avoided, as compared to prior devices that illuminate only a relatively small portion of the rod. Further, in low light conditions, humans, who typically utilize stereo vision, can much more accurately assess the distance to an object and direction of movement of the rod assembly 110, because, if the assembly 110 emits light from multiple sources at fixed distances from each other. By utilizing multiple light sources, the rod assembly therefore allows observes, such as oncoming drivers, to better assess the speed and direction of the vehicle on which the rod assembly is mounted. Visibility of the rod assembly can be even further enhanced by adding circuits to cause one or more light sources on the rod assembly to flash.

A flag 126 can be attached to the rod assembly 100 at any convenient location, such as at the upper end of the rod assembly 100 as shown in FIG. 1. The flag 126 can be made of any suitable material, including fabrics, fibrous materials such as paper or cardboard, or plastic and may be made in any desired shape, size, color, or design. For example, the flag may include the name, insignia, emblem, or design of a sports team, a military service, an advertisement, a trademark, or an organization. In certain embodiments, reflective or brighter colors may be used on the flag 126 in order to increase visibility. In addition, additional light sources, such as a string of LEDs, can be mounted to the flag 126 to further enhance its visibility. However, the flag 126 is optional and may be omitted, if desired.

A power source 128 for the light sources 124 can be mounted to, or otherwise associated with, the bottom end of the rod 110 opposite the flag 126. However, the power source 128 may be mounted in other locations on the assembly 100 or separate from the assembly 100. The power source 128 may include batteries or a generator. The number and type of batteries, or generator strength, depends on the power requirements of the light emitting sources 124 in the lighted rod assembly 100, the desired operating time, and the desired size of the power source 128. In certain implementations, the power source 128 includes two or four “AA” batteries, which can be disposable or rechargeable batteries. In another implementation, the power source 128 can include batteries and a generator, which can be used to recharge the batteries.

In certain embodiments, the rod assembly 100 can include conventional light rope extending along one or more sections of the rod 110 and/or the flag 126. For example, light rope can be positioned inside the rod 110 in lieu of or in addition to light sources 124, or light rope can be spirally wrapped around the outside of the rod 110.

As shown in FIG. 1, the rod 110 can be supported by a mounting bracket 130 that is adapted to be mounted to a vehicle, such as (without limitation) a bicycle, motorcycle, wheelchair, scooter, or baby stroller. The mounting bracket 130 in the illustrated configuration is secured to the lower end portion of the rod 110 and is formed with a U-shaped slot or notch 132 for being received on the skewer of a bicycle hub. The mounting bracket 130 can also serve as a mount for the power source 128, as depicted in FIG. 1. In one implementation, a housing or casing for batteries can be mounted to the mounting bracket 130.

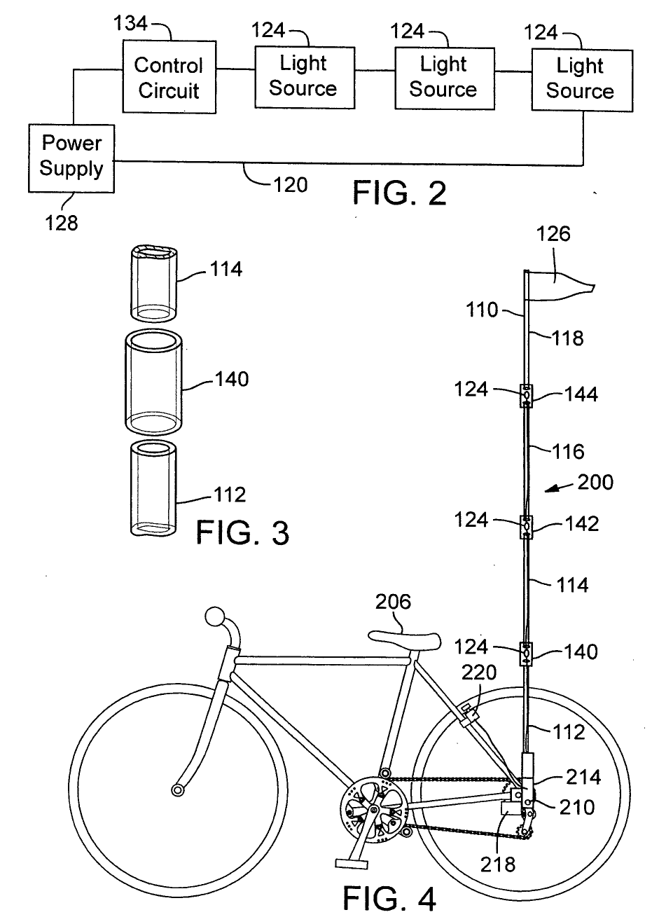

FIG. 2 shows an exemplary embodiment of a simplified electrical schematic of the lighted rod assembly 100. The electrical circuit can include a control circuit 134 electrically connected to the power source 128 and light sources 124 by the wiring harness 120. The control circuit 134 can be mounted within the rod 110, a housing for the power source or other structure. The control circuit 134 can be operable to control the light intensity of the light sources 124 and/or cause the lights to flash. These types of flasher circuits and light intensity control circuits are well known to those skilled in the art.

In the embodiment of FIG. 1, the rod 110 can be formed from multiple rod sections 112, 114, 116, 118 interconnected by plastic tubular sleeve sections 140, 142, 144 mounted to the external periphery of the rod sections 112, 114, 116, 118. FIG. 3 shows the assembly of rod sections 112, 114 and sleeve section 140, which are exemplary of the other rod and sleeve sections. As shown, each sleeve section includes open end portions, each of which is sized to receive an end portion of a respective rod section. The rod sections are sized to form a frictional fit with the inner surfaces of the sleeve sections to assist in securing the components together. A suitable adhesive or bonding agent can be applied to the mating surfaces of the rod sections and sleeve sections to promote a good bond between the mating components. In another implementation, the end portions of the rod sections can be provided with external threads that engage internal threads of the sleeve sections. In this manner, the rod sections can be simply screwed into the sleeve sections to assemble the rod.

In alternative embodiments, the rod 110 can be a continuous, unitary rod without multiple rod sections.

As shown in FIG. 1, the light emitting sources 124, and associated mounting hardware (not shown), may be mounted within the tubular sleeve sections 140, 142, 144. The wiring harness 120 may be secured to the mounting hardware of the light sources to provide power from the power source 128 to the light emitting sources 124. In this fashion, the lighted rod assembly 100 may be manufactured or assembled in varying lengths to provide varying rod lengths using the same basic components. In particular embodiments, the end user can add or remove rod and sleeve sections to adjust the length of the rod assembly for a particular application.

FIG. 4 shows a lighted rod assembly 200 mounted to the rear hub of a bicycle 206. This embodiment shares many similarities with the embodiment of FIG. 1. Hence, components in FIG. 4 that are identical to corresponding components in FIG. 1 have the same respective reference numerals and are not described further.

The lighted rod assembly 200 can be mounted to the skewer 210 of the rear hub of the bicycle 206 by a cycle mount bracket 214. The lighted rod assembly 200 can be powered by batteries in a power pack or power supply 218 and/or by a generator 220 in contact with a bicycle wheel. The lighted rod assembly 200 can be attached to either the left or the right side of the bicycle 206, as desired and depending on the design bicycle. The power pack 218 can comprise a housing sized and shaped to house one or more batteries and having a removable cover or panel to access the batteries.

The generator 220 can be any commercially available tire-driven generator, such as a Dymotec® tire-driven generator, available from Busch & Muller KG. Alternatively, the generator can be any commercially available hub generator, such as a model DH-3N70 generator, available from Shimano, Inc. In either case, the generator can be electrically connected to the wiring harness 120 to supply electric current to the light sources 124 upon rotation of the bicycle wheel. The generator can be electrically connected so as to supply electric current to the batteries of power pack 218. The control circuit 134 can include a switch that is operable to alternately establish an electrical circuit between the generator and the light sources when the bicycle is in motion and an electrical circuit between the batteries and the light sources when the bicycle is at rest and the generator is not generating electric current.

FIG. 5 is a detailed view of the lighted rod assembly 200 mounted to the rear skewer 210 of the bicycle 206. The mounting bracket 214 has a U-shaped mounting slot, or notch, 216 formed at its lower end which is slid onto the skewer 210 and secured in place by tightening the skewer 210 against the bracket using lever 222. The lower rod section 112 can be secured to the mounting bracket 214, such as by two strips of tape 224. Other fasteners or ties can be used, such as clamps or the like.

As shown, the power pack 218 can be mounted to one side of the mounting bracket 214 and can be configured to accept four “AA” batteries 226. A removable cover (not shown in FIG. 5) can be placed on the power pack to enclose the batteries 226 and protect them from the elements. However, the power supply 218 can be mounted to the bicycle 206 in any suitable location and by any suitable means.

In at least one implementation, for example, a first strip of hook and loop fastener (not shown) is attached to the mounting bracket 214. A second, mating strip of hook and loop fastener (not shown) is attached to a portion of the power supply 218. The power supply 218 can thus be secured to the mounting bracket 214 by attaching the first strip of hook and loop fastener to the mating strip on the power supply 218. Wires 236 electrically connect the power supply 218 to the lights 124 (FIG. 4) of the lighted rod assembly 200.

Referring now to FIG. 6, an alternative embodiment of a lighted rod assembly 300 is shown mounted to the skewer 210 of the rear hub of a bicycle 206. The lighted rod assembly 300 includes a lower rod section 112 secured to a mounting bracket 310, similar to mounting bracket 214 of FIGS. 4 and 5. The upper portion of the rod assembly not shown in FIG. 6 can be of the same construction as rod 110 shown in FIG. 1.

A power supply 312 can be mounted to the mounting bracket 310, such as with an adhesive or a fastener (not shown), including mating sections of hook and loop fastener applied to the back of the power supply 312 and the mounting bracket 310. Alternatively, the mounting bracket 310 and the power supply 312 can be integrally formed as one component. One or more batteries 316 (such as two batteries 316 in the illustrated embodiment, which may be “AAA” batteries) are located in the power supply 312 and are connected to wires 326 extending through the lower rod section 112. The wires 326 supply power to lights 124 (not shown in FIG. 6) within, or adjacent to, the rod 110.

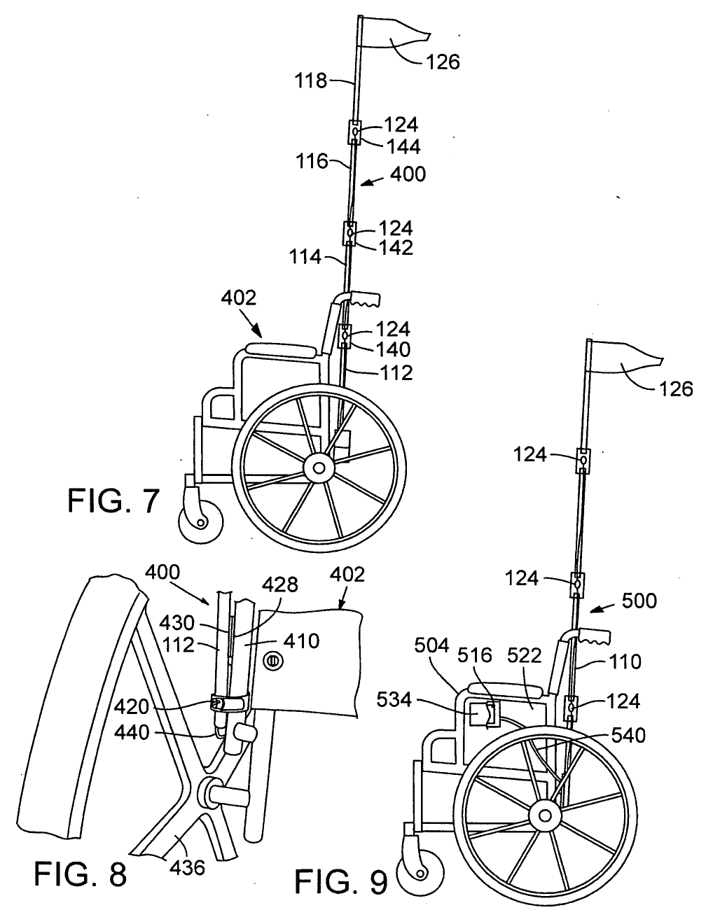

FIG. 7 shows a lighted rod assembly 400 mounted to a wheelchair 402, according to another embodiment. The rod assembly of this embodiment shares many similarities with the embodiment of FIG. 1. Hence, components in FIG. 7 that are identical to corresponding components in FIG. 1 have the same respective reference numerals and are not described further.

The lighted rod assembly 400 can be mounted at any convenient location on the wheelchair 402. For example, the lighted rod assembly 400 may be mounted to a rear side of the wheelchair 402. A flag 126 can be mounted at the top of the rod 110 and is made of a brightly colored material. The flag may alternatively include labels, light emitting sources (such as LED's secured to the flag material), or other indicia. Light emitting sources 124 can be mounted within the rod assembly 400 as shown (or on the outside of the rod assembly) and/or on the flag 404 and may be arranged to provide indicia or readable characters. The indicia may be a wide variety of symbols, for example, trademarks, team or school logos or names, military service, or requests for assistance or indication of an emergency to passers-by.

As shown in FIG. 8, the lighted rod assembly 400 can be mounted to the left rear seat post 410 of the wheelchair 402. A lower rod section 112 of the rod assembly 400 can be mounted to the seat post 410 by a band clamp 420. A strip of hook and loop fastener 428 may be attached to the upper portion of the seat post 410. Another strip of hook and loop fastener 430 may be attached to the lower rod section 112 and then mated with strip 428 to further secure the rod section 112 to the seat post 410. The strip 428 also can be used to secure a power supply to the post 410 (not shown in FIG. 8). Alternatively, a generator (not shown), which can be either a tire-driven generator or a hub generator, can be utilized to generate electric current for energizing the light sources and/or recharging batteries upon rotation of wheels 436 of the wheelchair 402. A wire 440 connects the power supply to the lights (not shown in FIG. 8) in the rod assembly 400. Although shown mounted to a rear corner of the wheelchair 402, the lighted rod assembly 400 may be attached to any suitable surface of the wheelchair 402, including the back or sides.

FIG. 9 illustrates a lighted rod assembly 500 mounted to a wheelchair 504, according to another embodiment. As in the lighted rod assemblies shown in FIGS. 7 and 8, the lighted rod assembly 500 includes a rod 110 mounted at the rear corner of the wheelchair 504. A power supply 516 for the lighted rod assembly 500 can be mounted to the left side 522 of the wheelchair 504. For example, as shown in FIG. 9, a patch 534 of hook and loop fastener can be attached to the left side 522 of the wheelchair 504. The power supply 516 can be provided with a mating strip of hook and loop fastener (not shown) for attachment to the patch 534. A wire 540 connects the power supply 516 to a series of lights 124 in the rod 110.

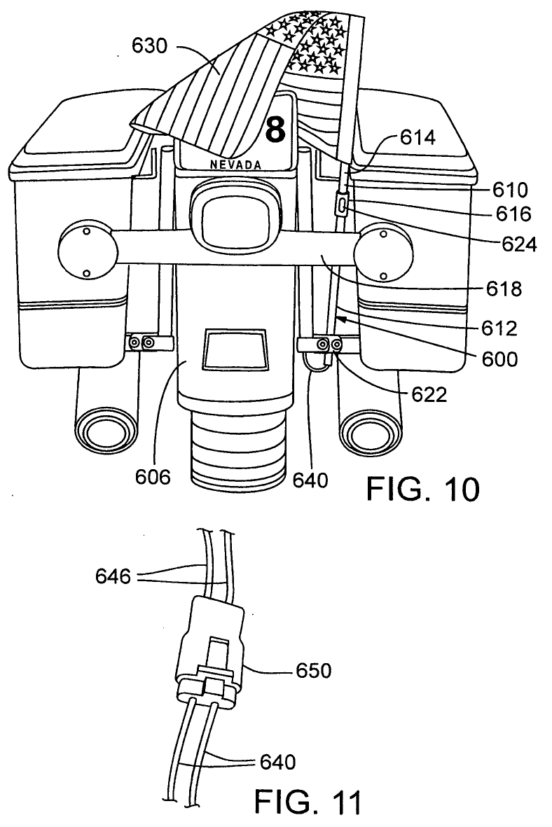

FIG. 10 illustrates a lighted rod assembly 600 shown mounted on a motorcycle 606. The rod assembly 600 in the illustrated embodiment comprises an elongated rod 110 comprised of rod sections 612, 614 and a sleeve section 616 coupling the rod sections 612, 614. The lower rod section 612 can be mounted to the right side of a horizontally extending tail light support bar 618. The rod section 612 can also be mounted to a lower saddle bag support bracket 622, which supports a saddlebag 624. The rod 610 may be mounted to the tail light support bar 618 and the lower saddle bag support bracket 622 by any suitable means, including hook and loop fasteners, clamps, adhesives, and fasteners, such as tape. A flag 630 can be mounted to the rod 610 at any convenient location, such as on the upper rod section 614 as shown. The lighted rod assembly 600 can be connected to a power supply (not shown), such as a battery or a generator, by wires 640. The lighted rod assembly 600 is not limited to the configuration shown in FIG. 10 and may be mounted in other locations, to other motorcycle components, and by other means.

Rather than providing a separate power supply for the lighted rod assembly 600 as in previously described embodiments, wires 640 can be electrically connected to the electrical system of the motorcycle 606, as illustrated in FIG. 11. As shown, the wires 640 can be connected to electrical system wires 646 of the motorcycle by an electrical connector 650. The electrical system wires 646 may be connected to a switch (not shown) on the motorcycle 606, such as the headlight switch.

It can thus be seen that the present disclosure provides a lighted rod assembly that can be used with a variety of transportation devices. The lighted rod assembly can be used to increase a user's safety, such as by increasing their visibility. The lighted rod assembly can also be used for decorative purposes.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A lighted rod assembly for mounting to a vehicle, the assembly comprising:
an elongated rod;
a plurality of electric light sources spaced along the length of the rod;
a power source electrically connected to the light sources; and
a mounting bracket supporting the rod and configured to be mounted on the vehicle.

2. The lighted rod assembly of claim 1, further comprising a power supply harness electrically connecting the power source to the electric light sources.

3. The lighted rod assembly of claim 1, wherein the electric light sources are housed within the rod.

4. The lighted rod assembly of claim I, wherein the power source comprises one or more batteries mounted adjacent one end of the rod.

5. The lighted rod assembly of claim 1, wherein the power source comprises a generator configured to generate electric current upon rotation of a wheel of the vehicle.

6. The lighted rod assembly of claim 1, wherein the power source comprises a power source of the vehicle.

7. The lighted rod assembly of claim 1, wherein the rod comprises a plurality of rod sections and sleeve sections, each sleeve section being positioned between two rod sections and having open ends that receive respective end portions of the rod sections.

8. The lighted rod assembly of claim 7, wherein the electric light sources are disposed in the sleeve sections.

9. The lighted rod assembly of claim 1, further comprising a flag mounted to the rod.

9. The lighted rod assembly of claim 1, wherein the electric lights sources comprise LEDs.

10. The lighted rod assembly of claim 1, wherein the rod has a lower end secured to the mounting bracket, an upper end, and a length extending between the lower and upper ends, and wherein the rod can be illuminated by the light sources along the entire length of the rod.

11. The lighted rod assembly of claim 1, wherein the mounting bracket includes a mounting slot adapted to be received on a skewer of a bicycle hub.

12. The lighted rod assembly of claim 1, in combination with the vehicle, the lighted rod assembly being mounted on the vehicle.

13. An assembly comprising:
a vehicle; and
a lighted rod assembly mounted to the vehicle and comprising an elongated rod and a plurality of light sources mounted at spaced apart locations along the length of the rod.

14. The assembly of claim 13, wherein the lighted rod assembly further comprises a power source electrically connected to the light sources, the power source being mounted adjacent a lower end portion of the rod.

15. The assembly of claim 13, wherein the vehicle comprises a bicycle and the lighted rod assembly includes a mounting bracket, the mounting bracket supporting the elongated rod and having a mounting slot, and wherein a skewer of the bicycle extends through the mounting slot and is tightened against the mounting bracket to secure the lighted rod assembly in place.

16. The assembly of claim 13, wherein the vehicle comprises a motorcycle and the light sources are electrically connected to the electrical system of the motorcycle.

17. The assembly of claim 13, wherein the rod comprises a plurality of rod sections and sleeve sections, each sleeve section being positioned between two rod sections and having open ends that receive respective end portions of the rod sections.

18. A lighted rod assembly for mounting to a vehicle, the assembly comprising:
an elongated rod comprising a plurality of rod sections and sleeve sections, each sleeve section being positioned between two rod sections and having open ends that receive respective end portions of the rod sections;
a plurality of electric light sources positioned in the sleeve sections;
a power source electrically connected to the light sources; and
a mounting bracket supporting the rod and configured to be mounted on the vehicle.

19. The lighted rod assembly of claim 18, wherein the majority of the length of the rod can be illuminated by the light sources.

20. The lighted rod assembly of claim 19, wherein a lower end portion of the rod is secured to the mounting bracket.

21. The lighted rod assembly of claim 20, wherein the power source is carried by the mounting bracket.

22. A method of using a lighted rod assembly comprising an elongated rod and a plurality of electric light sources spaced along the length of the rod, the method comprising:
mounting the rod assembly to a vehicle; and
energizing the light sources to illuminate the rod.

23. A lighted rod assembly for mounting to a vehicle, the assembly comprising:
an elongated rod comprising a plurality of rod sections and sleeve sections, each sleeve section being positioned between two rod sections and having open ends that receive respective end portions of the rod sections, one of said rod sections comprising a lower rod section;
a flag mounted to the rod;
a plurality of LEDs positioned in the sleeve sections at spaced apart locations along the length of the rod;
a mounting bracket configured to be mounted on the vehicle, the lower rod section being secured to the mounting bracket;
a power source mounted adjacent the mounting bracket and comprising one or more batteries; and
a wiring harness extending through the rod assembly and being electrically connected to the LEDs and the power source;
wherein the LEDs illuminate substantially the entire length of the rod assembly when energized by the power source.
